(19) United States
(12) Patent Application Publication
(10) Pub. No.: US 2003/0071517 A1
(43) Pub. Date: Apr. 17, 2003

(54) Steering brake system with electrically controlled valves

(76) Inventor: Rudolf Weil, Frankfurt (DE)

Correspondence Address: RATNERPRESTIA, P O BOX 980, VALLEY FORGE, PA, 19482-0980, US

(21) Appl. No.: 10/244,957

(22) Filed: Sep. 16, 2002

(30) Foreign Application Priority Data
Sep. 17, 2001 (DE) 101 45 789.8

(51) Int. Cl. B60T 13/00

(52) U.S. Cl. 303/9.61

(57) ABSTRACT

The present invention relates to a brake system for vehicles in which the brakes in a first operating mode serve for a steering brake operation and in a second operating mode for braking the vehicle when driving on a road. In such brake systems one has to take care that only the brakes of the rear axle can be controlled independently from each other during the steering brake operation. On the other hand one has to ensure that at least the brakes of the rear axle are actuated together when driving on a road and, if necessary, the brakes of the front axle are controlled in parallel. In order to achieve this function, the state of the art includes complicated mechanical valves or sophisticated special arrangements in the master cylinders being used. It is the object of the present invention to simplify the known generic brake systems. For this reason the invention proposes to utilise electrically controlled valves. Advantageous developments of the present invention describe the application of the above-mentioned valves in vehicles braked in one axle and in two axles. It is furthermore suggested to integrate the valves together in one valve block.

### FIELD OF THE INVENTION

The present invention relates to a hydraulic brake system for vehicles, steering the vehicle in a first operating mode (driving on agricultural land) by means of two brakes which can be separately actuated and braking the vehicle in a second operating mode (driving on a road) by means of actuating the brakes simultaneously. Various solutions have been disclosed in this regard. In a first known solution only the brakes of the rear axle are actuated.

### DESCRIPTION OF PRIOR ART

FIG. 1 shows the diagram of a known brake system in which only the brake calipers 1,2 of the rear axle (RA) are actuated when driving on a road. The vehicle, e.g. a harvester-thresher or a tractor, is thus braked only on one axle, as described in FIG. 1. Furthermore only one wheel brake of the rear axle should be actuated in case of a steering brake operation. The vehicle has two pedals 3,4 with one master cylinder 5,6 each. Each pedal is provided with an electric switch not shown in FIG. 1 causing a stop light to light up that is assigned to the respective pedal and is not shown in FIG. 1, in case only one or both pedals 3,4 are actuated.

When driving on the road, these pedals are mechanically connected. Pressure is built up in both master cylinders when both pedals are actuated simultaneously, and pressure is applied to the brakes 1,2 (left and right) what leads to a braking operation. Pressure and volume compensation between the two master cylinders must be performed since the wheel brakes 1,2 possibly take up different volumes and the tolerances in the master cylinder 5,6 are also different. In the known arrangement according to FIG. 1, the compensation is carried out on the basis of a compensating valve 7 working as follows. The compensation valve accommodates a floating piston which is able to compensate up to 1.8 cm of volume if the wheel brakes left/right take up a different volume. This compensation is performed by shifting of the piston in the compensation valve. If there is too much volume to be compensated, the piston closes the output towards which it was moved.

When driving on agricultural land, the mechanical coupling of the pedals 3,4 which is necessary for driving on a road, is released. Thus a steering brake operation can be achieved, if necessary, by actuating only one pedal with the assigned master cylinder (3,5 or 4,6) which builds up brake pressure only in this master cylinder and thus also only in the respective wheel brake 1 or 2. Piston 8 in compensation valve 7 is shifted to the opposite side and closes the line to the other master cylinder and the wheel brake. When actuating e.g. pedal 3 and building up a pressure in the master cylinder 5, piston 8 of compensation valve 7 in FIG. 1 moves downward, so that piston 8 interrupts the connection between master cylinder 6 and brake caliper 2 preventing the effect of brake caliper 2. Thus brake pressure can only arrive at the wheel brake assigned to the respective master cylinder being actuated and the steering brake operation can be performed.

FIG. 5 shows another known solution for a generic brake system is shown in FIG. 5. The known solution shown in this FIG. consists in steering only with the brakes 1,2 of the rear axle RA when driving on agricultural land and/or during steering operation. When driving on a road, however, the vehicle is braked with all brakes 1,2,9,10 on both axles RA, FA.

The brake system described in FIG. 5 works as follows. The vehicle, e.g. a tractor, is braked on two axles, i.e., on the rear axle RA as well as on the front axle FA. In addition to that it should be possible to carry out a steering brake operation during which only one of the rear axle brakes shall be braked with brakes 1,2. The vehicle, on the other hand, has two pedals 3,4 with one master cylinder 5 or 6 each. Each pedal 3,4, again, has one electrical switch not shown in FIG. 5 making the stop light light up, if only one or both pedals 3,4 are actuated. In case of a steering brake operation, only the brakes 9,10 of the front axle FA must not be actuated. Pressure and volume compensation is carried out by means of the compensation valve 7, similar to the vehicles braked on RA according to FIG. 1.

The connecting valve 11 connects the front axle brakes for driving on the road. When driving on the road, both brake pedals are coupled with one another, as described in relation to FIG. 1. On actuating one of the two pedals, pressure is built up in both master cylinders 5,6. A floating piston 8 is located in the compensation valve 7, as already described in FIG. 1, which is able to compensate up to 1.8 cm of volume if the wheel brakes left/right take up different volumes. The pressure outputs 12,13 of the compensation valve lead to the connecting valve 11, which opens the pressure line 14 to the front axle FA by means of small mechanical valves, if pressure is applied on both sides on the outputs 12,13. Thus all wheel brakes of the RA and the FA can be actuated in case of driving on the road and coupled pedals 3,4.

When driving on agricultural land with a configuration according to FIG. 5, the mechanical coupling of the brake pedals 3,4 is released. When only one pedal is actuated (e.g. 3 or 4), brake pressure is built up only in this master cylinder and thus only in the appropriate wheel brake 9 or 10. The piston 8 in the compensation valve 7 is shifted to the opposite side and closes the line to the other master cylinder and the other wheel brake. In this case the connecting valve 11 is applied with pressure only from one side. The pressure output to the front axle remains always closed. Accordingly, the brakes 9,10 on the front axle FA are not actuated. Brake pressure can thus only arrive at the RA wheel brake belonging to the master cylinder that has been actuated. Then the steering brake operation can be carried out. If pedal 3 is actuated, the master cylinder 5 releases a pressure at its output, by which master cylinder 6 is separated by means of the compensation valve 7. Due to the asymmetrical pressure on the connecting valve 11, the pressure line 14 is blocked so that only the brakes 1,2 on the rear axle carry out the steering brake operation.

It is considered to be a disadvantage of the known brake systems according to FIGS. 1 and 5 that they need special mechanical compensation valves, as described above, and additionally have a special mechanical connecting valve with regard to the solution for two axles. Such mechanical valves are unfavourable because of their weight, the limited volume compensation, the required mounting space and their reliability. Systems have also become known which do not need a compensation valve. Since a volume compensation must be provided for in case of a parallel arrangement of the master cylinders due to the given tolerances which otherwise is carried out by the compensation valves, said volume compensation is made within the master cylinders by means of complicated constructions. This leads to considerable costs for the known systems.

### BRIEF SUMMARY OF INVENTION

The present invention therefore is based on a hydraulic brake system for vehicles with two brake pedals after which one master cylinder each and a signal transmitter is inserted signaling the actuation of the assigned pedals, the pedals being actuatable independently from one another for a steering brake operation when driving on agricultural land, whereas the pedals can only be actuated together when driving on a road, control means being provided which separate the master cylinders from one another when driving on agricultural land and connect them to at least one assigned brake caliper each and which switch the master cylinders parallel to each other when driving on a road and connect the master cylinders to the brake calipers of at least one vehicle axle.

It is the object of the present invention to simplify the known hydraulic brake system, to guarantee unlimited volume compensation between both master cylinders and to improve the mode of operation at least with regard to its reliability. This object is achieved in that the switching means are formed by electrically controlled valves. Thus, this invention consists in principle in replacing the known mechanical constructive elements described above by electrically controlled valves. Such valves are produced in large numbers of pieces and used e.g. for controlled brake systems. In addition, the electrically controlled valves work in a very reliable manner since they are a very relevant component part for the safety of vehicles in the other areas they are used for.

A particularly simple configuration of the brake system according to the present invention results from the use of the features in that the hydraulic outputs of the two master cylinders are connected directly to the brake calipers on the rear axle which are assigned to them. By using the electrically controlled valves according to the present invention, the pressure outputs of the master cylinders inserted after the pedals can be directly connected to the relative brake caliper of the rear axle. This type of arrangement is maintained in both operating modes so that a further simplification is achieved.

In case of electrically controlled valves it is further required to provide signals triggering the actuation control of the valves. A considerable simplification is achieved by applying the features that one switching control is provided which evaluates the output signals sent to it by the signal transmitter and controls the valves as a function of the output signals. Since the known generic brake systems have a signal transmitter associated to each pedal anyway, the former indicating the actuation of the associated pedal and being necessary for actuating the brake light, such signals, in a further development of the present invention, are utilised for operating the electrically actuated valves. Thus the configuration for the required control of signals is very simple and is based on the principle that during a steering brake operation the pedals are actuated separately from each other. Thus, as a rule, only one signal transmitter sends a signal in this operating mode. It is, however, no disadvantage, if both pedals are actuated simultaneously during steering braking, since the vehicle is driving straight ahead even if both pedals are actuated. The force applied on the pedal is a measure for the braking force applied by the brake. It cannot be expected, however, that the driver actuates both pedals simultaneously with high force, because in such a case he would show the desire to drive abruptly to the right and to the left at the same time.

A particularly simple configuration for a brake system in which only the brakes on the rear axle are activated, is represented in an advantageous development of the invention with regard to the features that the switching control is provided with only one NO valve whereby the outputs of the two master cylinders can be connected to each other. According to that, one single, normally open electrically switched valve (NO valve) is sufficient to operate the vehicle in both operating modes.

According to a further development of the invention, if a vehicle is to be steered with both brakes on the rear axle and braked with all four brakes when driving on a road the combination of features is recommended, that the switching means are provided with two NO valves connected in series whereby the outputs of the two master cylinders can be connected to each other, and that the line connecting the two NO valves can be connected to the two brake calipers of the front axle by a NC valve.

Compared with this combination of features a further simplification can be achieved with the same setting of tasks, by applying the features that the switching means are provided with a first NO valve, whereby the outputs of the two master cylinders can be connected with each other, so that a line connecting a master cylinder with a first NO valve may be connected with the two brake calipers of the front axle by means of a second NO valve.

A considerable simplification and space-saving arrangement may result from using the features that at least a part of the valves is integrated together in one valve block. Valve blocks with a multitude of integrated electrically controllable valves are produced in a high number of pieces for controlled brake systems and are thus very space-saving and comparably inexpensive.

### BRIEF DESCRIPTION OF THE DRAWINGS

The following drawings describe embodiments of the present invention showing

FIG. 1—the configuration of a known brake system in which the braking operation is carried out only with the two brakes on the rear axle when driving on a road.

FIG. 2—the configuration of a brake system according to the present invention, satisfying the requirements described with regard to FIG. 1.

FIGS. 3 and 4—the condition of the utilised valve in the different operating modes.

FIG. 5—the configuration of a known brake system in which the braking is carried out with the four brakes of the two axles when driving on the road.

FIG. 6—the configuration of the brake system according to the present invention satisfying the requirements described with regard to FIG. 5 with three valves.

FIG. 7—an enlarged detail of FIG. 6.

FIGS. 8 to FIG. 10—the configuration of the valves according to FIG. 7 in the single operating modes.

FIG. 11—the configuration of the brake system according to the present invention satisfying the requirements described in FIG. 5 with two valves.

FIG. 12—the configuration according to FIG. 11 in a modified operating mode.

### DETAILED DESCRIPTION OF PREFERRED EMBODIMENTS

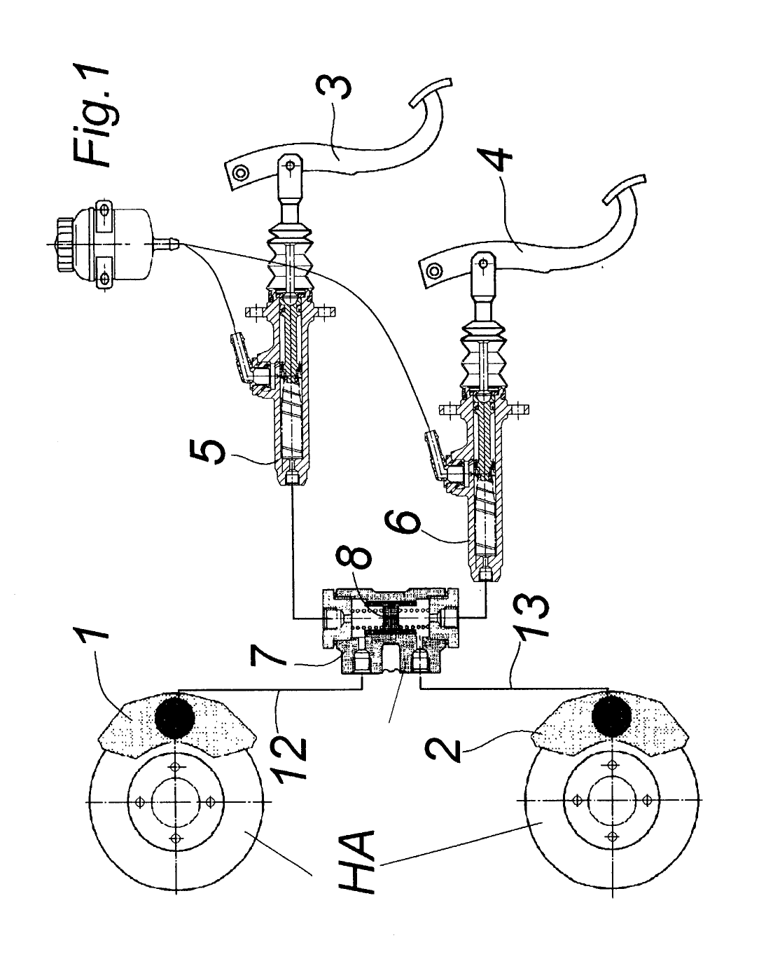

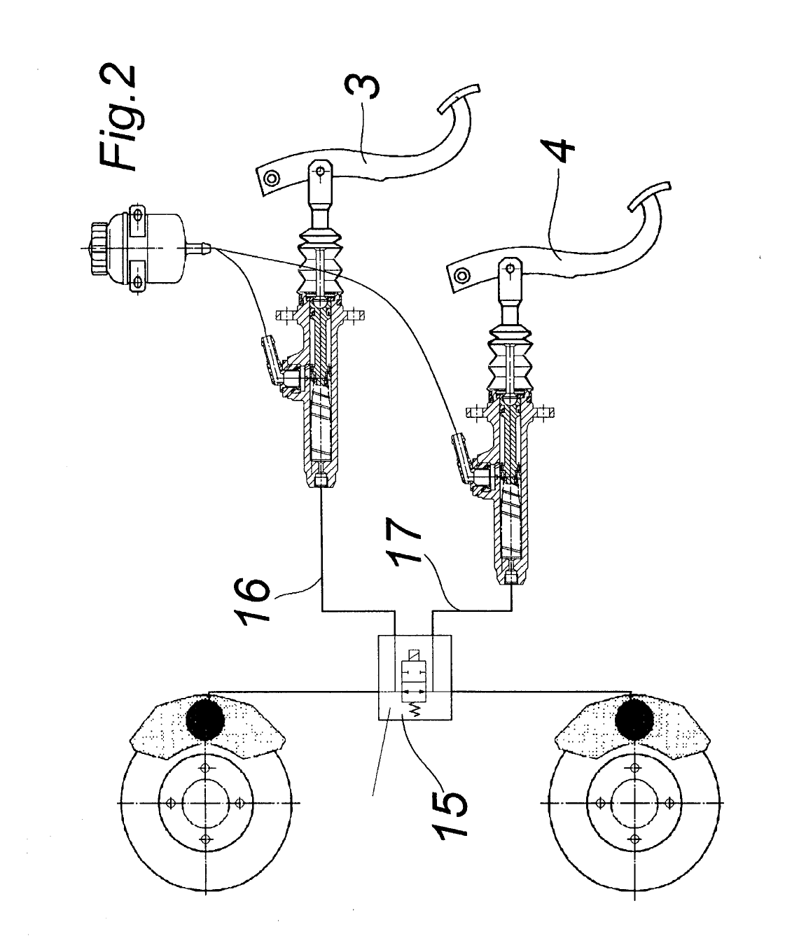

In the following the design of the brake system according to the present invention by means of electrically controlled valves is described on the basis of FIGS. 2 to 4. The mode of operation of the brake system according to the present invention described in FIG. 2 corresponds to the mode of operation of the known brake system according to FIG. 1, the design according to FIG. 2 offering, however, considerable advantages with regard to FIG. 1. The design of the system according to FIG. 2 is described only in so far as there are deviations from the known structure according to FIG. 1.

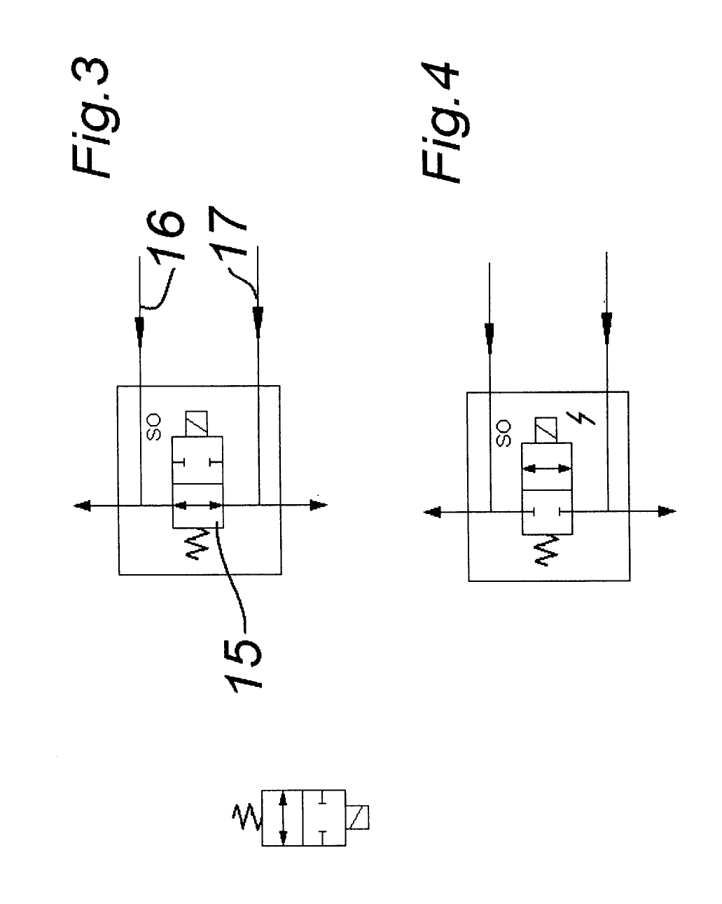

If in the brake system according to FIG. 2 both pedals 3,4 which are mechanically coupled, are actuated when driving on a road, according to the present invention also two electrical switches (not shown in FIG. 2) for the stop light are simultaneously actuated by the pedals 3,4. The arrangement of the switches at the pedals is known, the switches serving for switching on the brake light of the pedal 3 respectively 4 which is being actuated. The signals coming from the two electrical switches are transmitted to a switch control not shown in FIG. 2. If the switch control receives an electric impulse from both pedal switches simultaneously, an electrically controlled, normally open valve 15 (NO valve) according to the present invention is not operated. If the impulses coming from the switches arrive at the same time, the NO valve 15 remains or switches into the initial position, as shown in FIG. 3. FIG. 3 also shows valve 15 in initial position as well as in the position during driving on a road, when both pedals are actuated at the same time. Therefore valve 15 continues to be open guaranteeing pressure and volume compensation.

If the mechanical coupling of the pedals (3,4) is released when driving on agricultural land, a steering brake operation may be initiated, if necessary, by actuating only one pedal (e.g. pedal 3). In this case the switch control receives only one single impulse from the switch being actuated on the pedal. The switch control (not shown) is now designed in such a way that it closes the normally open valve if it receives only one current impulse. Thus the connection to the other master cylinder (e.g. master cylinder 6) and wheel brake (e.g. wheel brake 2) is cut off and the steering brake operation can be carried out. When using the electrically controlled, normally open valve 15, it is an advantage that a permanent connection between both master cylinders and wheel brakes is ensured. Pressure and volume can be compensated without limitation.

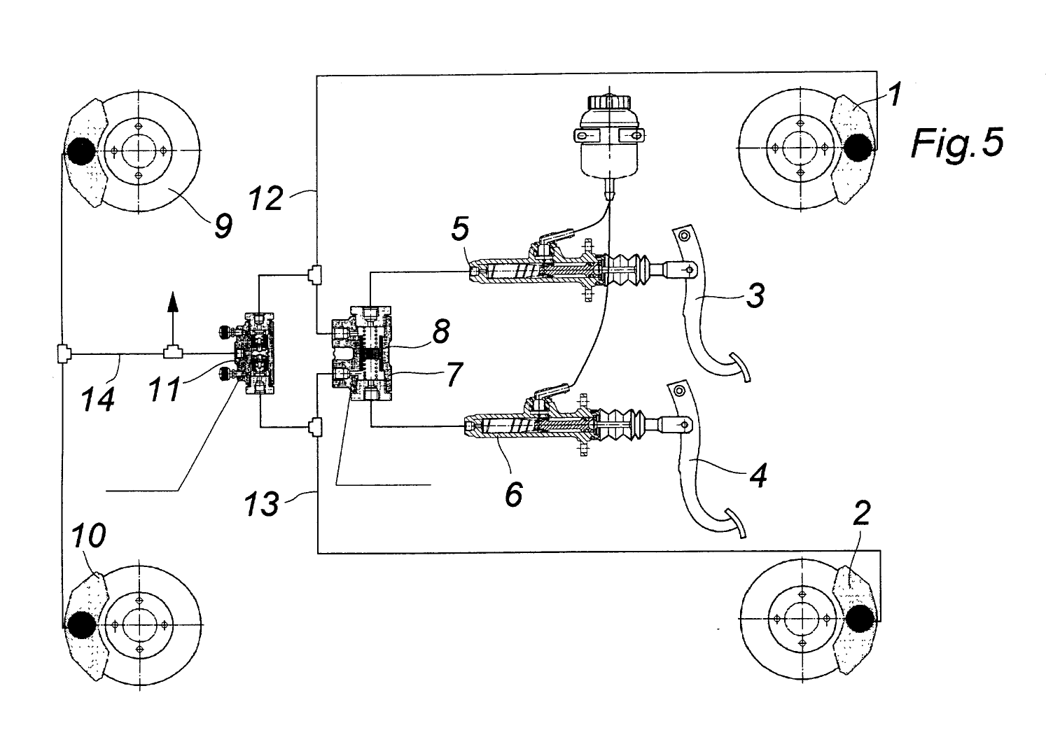

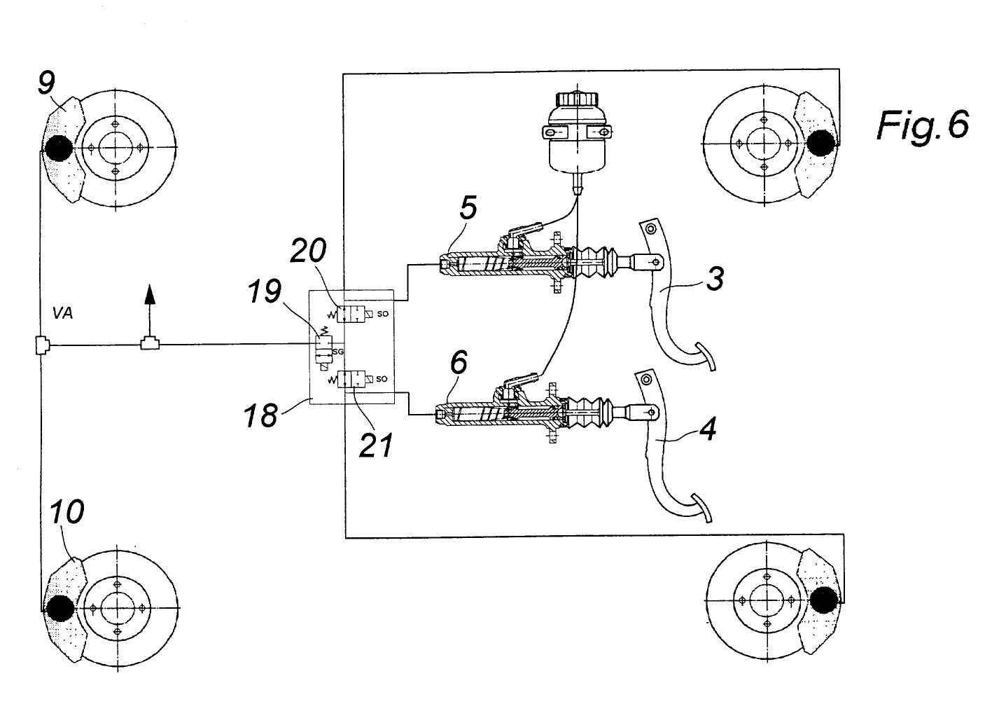

FIG. 6 shows a brake system according to the present invention satisfying the functions of the known brake system according to FIG. 5, the design of which according to FIG. 6, however, offers considerable advantages compared with the known brake systems shown in FIG. 5. The structure of the system according to FIG. 6 is described only insofar as there are differences with regard to the known design according to FIG. 5 and the embodiment according to FIG. 2. In FIG. 6, the above mentioned function according to FIG. 5 can be illustrated when a valve block 18 is used together with a normally closed valve 19 for connecting the front axle brakes 9,10 and two normally open valves 20,21.

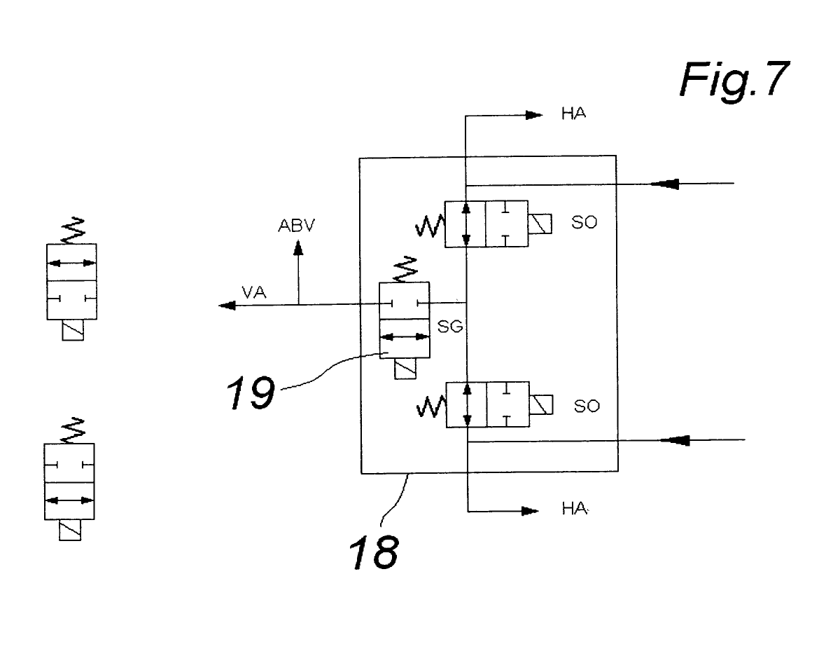

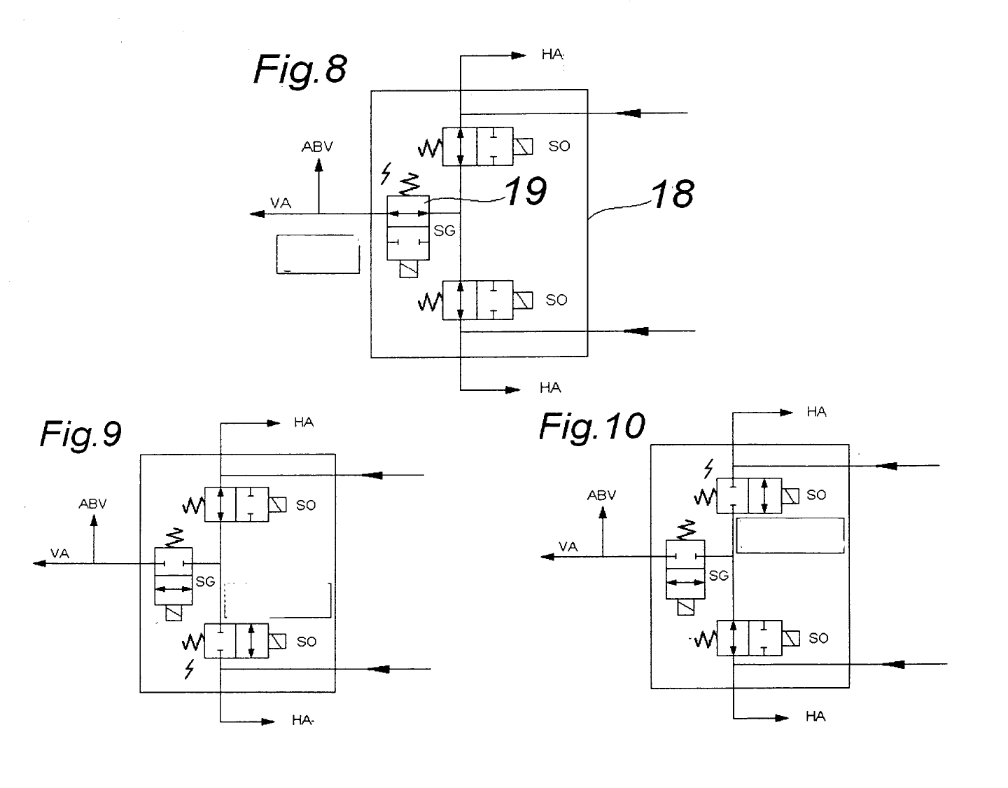

If both pedals 3,4 are actuated when driving on a road, the pedals being coupled mechanically, also both electrical switches are actuated simultaneously by the pedals for the stop light. The signals of both electrical switches are transmitted to a switch control. If the switch control receives an electrical impulse from both pedal switches, the NC valve is switched from the initial position shown in FIG. 7 into the working position shown in FIG. 8. The NC valve 19 will be opened (i.e. switched open) and the front axle brakes 9,10 can be actuated. In this case the two NC valves 20,21 are not operated and remain open. Thus the pressure and volume compensation between the two master cylinders 5,6 is unlimited.

If the mechanical coupling of the pedals 3,4 is released when driving on agricultural land, a steering brake operation can be initiated, if necessary, by actuating only one pedal 3 or 4. In this case the switch control receives only one impulse from the switch being actuated on the pedal being acted upon. On receiving only one current impulse, the switch control closes the normally open valve 20 and/or 21 belonging to the opposite master cylinder. Thus the connection to the other master cylinder and the wheel brake is cut off. The normally closed (or blocked) valve 19 is not switched if only one current impulse in the electrical switching relay is received. The connection to the front axle wheel brakes 9,10 remains closed, the steering braking can be carried out. The single conditions of the valves in case of the right or the left pedal being actuated are shown in detail in the FIG. 9 and 10.

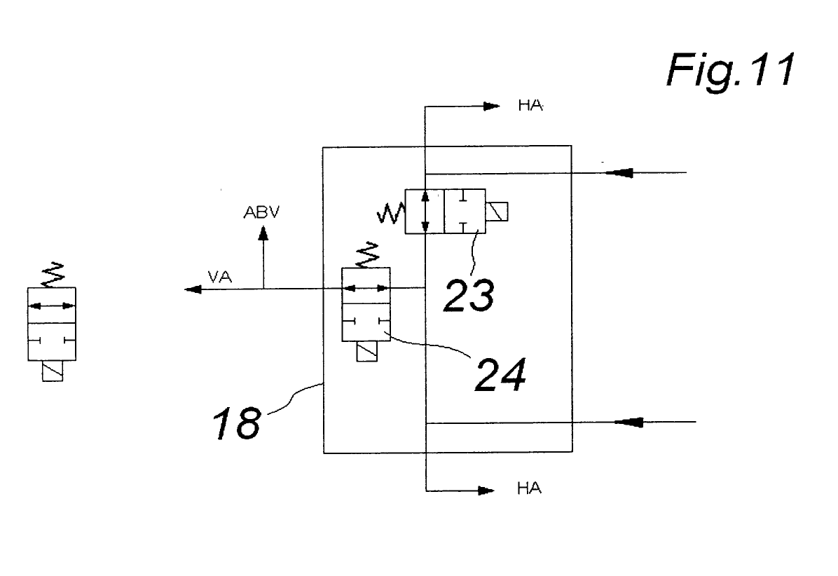

A further simplification of the brake system according to the present invention with the functions according to FIG. 7 can be achieved by the design described in connection with FIG. 10 and 11. The function of the steering brake operation can thus be realised also with a valve block 18 with only 2 normally open (switched open) valves 23,24. If only one pedal (e.g. pedal 3) is actuated when driving on agricultural land, both valves 23,24 are switched in to a blocking operating status. Thus the connection to the other master cylinder or to the brake on the front axle FA is closed (i.e. interrupted) and only the wheel brake to the master cylinder being actuated is actuated. When driving on the road, the switch control switches the electrical valve block actuation off, so that no valve is operated. All valves remain open so that an unlimited pressure and volume compensation between both master cylinders may be carried out. In such a way an undesired steering brake operation, e.g. failure of an electrical switch on the pedal, is prevented, when driving on the road.

If the electrical switch control is not switched off, the following is valid:

If both mechanically coupled pedals are actuated when driving on a road, also both electrical switches are actuated simultaneously by the pedals for the stop light. The signals from both electrical switches are transmitted to the switch control. If the switching relay of both pedal switches receives an current impulse, no valve is operated. All valves remain open so that an unlimited pressure and volume compensation between both master cylinders is possible.

If the mechanical coupling of the pedals is released when driving on agricultural land, a steering brake operation may be initiated, if necessary, by actuating only one pedal. In this case the switch control receives only one impulse from the switch on the pedal being actuated. On receiving only one current impulse, the switch control closes the normally open valve to the opposite master cylinder and to the front axle brake. Thus the connection to the other master cylinder and the other wheel brake as well as to the front axle brake is cut off, the steering brake operation may be carried out.

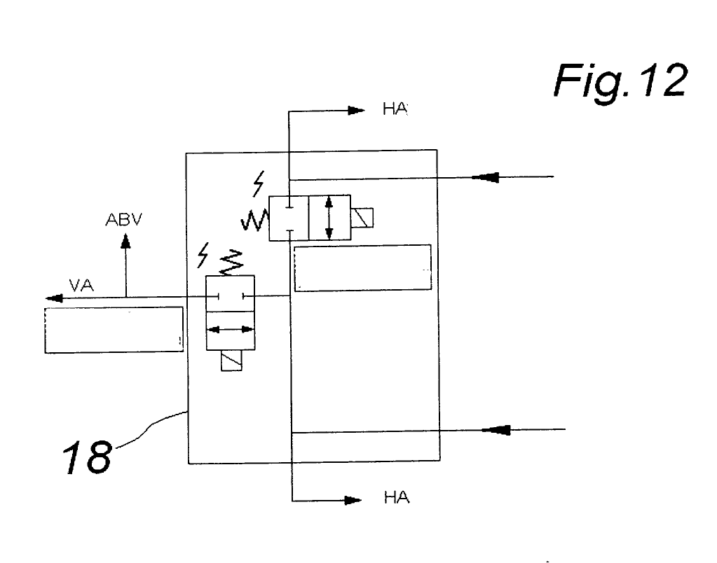

The new technical solution is illustrated by a valve block with a NO valve for vehicles braked in one axle respectively with a valve block with 2 NO valves and, if necessary, 1 NC valve which are all arranged in one common housing. Thus, unlimited volume compensation between the two master cylinders is ensured. At the same time the front axle can be connected in the case of vehicles braked on two axles.

| | |
|---|---|
| FIG. 1 | |
| Hinterachse | rear axle |
| Ausgleichventil | compensation valve |
| FIG. 2 | |
| Ventilblock mit | valve block with a NO valve |
| einem SO-Ventil | |
| FIG. 3 | |
| Hydraulischer Schaltplan . . . | hydraulic diagram |
| | valve block for the actuation of |
| | the steering brake operation in |
| | case of vehicles with 2 pedals, |
| | braked in 1 axle |
| SO-Ventil, stromlos offen | NO valve, normally open |
| HA rechts | RA right |
| vom Hauptzylinder rechts | from the right master cylinder |
| SO | NO |
| vom Hauptzylinder links | from the left master cylinder |
| HA links | RA left |
| FIG. 4 | |
| HA rechts | RA right |
| vom Hauptzylinder rechts | from the right master cylinder |
| SO | NO |
| Ventil geschlossen | valve closed |
| vom Hauptzylinder links | from the left master cylinder |
| HA links | RA left |
| FIG. 5 | |
| Vorderachse | front axle |
| VA rechts | FA right |
| zum Anhängerbremsventil | to the trailer brake valve |
| Zuschaltventil | connecting valve |
| VA links | FA left |
| Druckausgänge | pressure outputs |
| Ausgleichventil | compensation valve |
| HA rechts | RA right |
| HA links | RA left |
| Hinterachse | rear axle |
| FIG. 6 | |
| zum Anhängerbremsventil | to the trailer brake valve |
| VA | FA |
| SO | no |
| SG | nc |
| FIG. 7 | |
| Hydraulischer Schaltplan . . . | hydraulic diagram |
| | valve block for the actuation of |
| | a steering brake operation in case |
| | of vehicles with 2 pedals and |
| | connecting function for the front |
| | axle and the trailer brake valve |
| SO-Ventil stromlos | NO valve, normally open |
| geöffnet | |
| SG-Ventil stromlos | NC valve, normally closed |
| geschlossen | |
| ABV | trailer brake valve |
| VA | FA |
| HA rechts | RA right |
| vom Hauptzylinder rechts | from the right master cylinder |
| SO | NO (normally open) |
| SG | NC (normally closed) |
| vom Hauptzylinder links | from the left master cylinder |
| HA links | RA left |
| FIG. 8 | |
| VA | FA |
| ABV | trailer brake valve |
| SG-Ventil geöffnet | NC valve open |
| HA rechts | RA right |
| vom Hauptzylinder rechts | from the right master cylinder |
| SO | NO (normally open) |
| SG | NC (normally closed) |
| vom Hauptzylinder links | from the left master cylinder |
| HA links | RA left |
| FIG. 9 | |
| ABV | trailer brake valve |
| VA | FA |
| HA rechts | RA right |
| vom Hauptzylinder rechts | from the right master cylinder |
| SO | NO (normally open) |
| SG | NC (normally closed) |
| SO-Ventil geschlossen | NO valve closed |
| vom Hauptzylinder links | from the master left cylinder |
| HA links | RA left |
| FIG. 10 | |
| ABV | trailer brake valve |
| VA | FA |
| HA rechts | RA right |
| vom Hauptzylinder rechts | from the right master cylinder |
| SO | NO (normally open) |
| SG | NC (normally closed) |
| SO-Ventil geschlossen | NO valve closed |
| vom Hauptzylinder links | from the left master cylinder |
| HA links | RA left |
| FIG. 11 | |
| Ruhezustand . . . | Rest condition without actuation or |
| | both pedals actuated |
| Hydraulischer Schaltplan . . . | Hydraulic diagram |
| | Valve block for the actuation of |
| | a steering brake operation in case |
| | of vehicles with 2 pedals as well |
| | as connecting function for the |
| | front axle and the trailer brake |
| | valve |
| SO Ventil stromlos geöffn. | NO valve, normally open |
| VA | FA |
| ABV | trailer brake valve |
| HA rechts | RA right |
| vom Hauptzylinder rechts | from the right master cylinder |
| vom Hauptzylinder links | from the left master cylinder |
| HA links | RA left |
| FIG. 12 | |
| VA | FA |
| ABV | trailer brake valve |
| Ventil geschlossen | valve closed |
| HA rechts | RA right |
| vom Hauptzylinder rechts | from the right master cylinder |
| vom Hauptzylinder links | from the left master cylinder |
| HA links | RA left |

1. Hydraulic brake system for vehicles with two brake pedals after which one master cylinder each and a signal transmitter is inserted signaling the actuation of the assigned pedals the pedals being actuatable independently from one another for a steering brake operation when driving on agricultural land, whereas the pedals can only be actuated together when driving on a road, control means being provided which separate the master cylinders from one another when driving on agricultural land and connect them to at least one assigned brake caliper respectively each and which switch the master cylinders parallel to each other when driving on a road and connect the master cylinders to the brake calipers of at least one vehicle axle,
characterized in that the switching means are formed by electrically controlled valves.

2. Brake system according to claim 1,
characterized in that the hydraulic outputs of the two master cylinders are connected directly to the brake calipers on the rear axle which are assigned to them.

3. Brake system according to claim 1,
characterized in that one switching control is provided which evaluates the output signals sent to it by the signal transmitter and controls the valves as a function of the output signals.

4. Brake system according to the claim 1,
characterized in that the switching control is provided with only one NO valve whereby the outputs of the two master cylinders can be connected to each other.

5. Brake system according to the claim 1,
characterized in that the switching means are provided with two NO valves connected in series whereby the outputs of the two master cylinders can be connected to each other, and that the line connecting the two NO valves can be connected to the two brake calipers of the front axle by a NC valve

6. Brake system according to the claim 1,
characterized in that the switching means are provided with a first NO valve whereby the outputs of the two master cylinders can be connected with each other, so that a line connecting a master cylinder with a first NO valve may be connected with the two brake calipers of the front axle by means of a second NO valve

7. Brake system according to the claim 1,
characterized in that at least a part of the valves is integrated together in one valve
